(19) United States
(12) Patent Application Publication
(10) Pub. No.: US 2014/0352470 A1
(43) Pub. Date: Dec. 4, 2014

(54) BALL SCREW ASSEMBLY AND WIPER

(71) Applicant: UNIVERSAL TRANSMISSION MOTION CORP., Taichung City (TW)

(72) Inventor: WEN-YU HSIEH, TAICHUNG CITY (TW)

(21) Appl. No.: 13/903,135

(22) Filed: May 28, 2013

(51) Int. Cl. F16H 25/22

(52) U.S. Cl. CPC F16H 25/2204
USPC 74/424.82

(57) ABSTRACT

A wiper for screwing on a rolling groove of a screw shaft includes a ring and a plurality of wiping protrusions extended from the inner surface of the ring. The ring has a plurality of dust discharge grooves formed on an inner surface thereof. The inner surface of the ring substantially configured to abut an outer surface of the screw shaft. Each wiping protrusion is arranged between any two adjacent dust discharge grooves. When the wiper screws on the rolling groove of the screw shaft, the wiping protrusions are arranged in and compressed by the rolling groove of the screw shaft, and a portion of the rolling groove touched with the wiping protrusions is arranged in a single pitch of the screw shaft. The instant disclosure also provides a ball screw assembly.

### BACKGROUND OF THE INVENTION

1. Field of the Invention

The instant disclosure relates to a motion guide device; more particular, to a ball screw assembly and a wiper.

2. Description of Related Art

The general motors are operating in rotating movement, but if needing to do linear positioning movement, the motors need to rely on the ball screw assembly. Guiding the rotating movement of the motors into the linear positioning movement, it was also to do with the tooth row, chain, or belt, but after all, its accuracy or stroke accuracy is not as good as the ball screw assembly.

In the manufacturing process of the screw ball assembly, the balls are arranged in the space surroundingly defined by the screw shaft and the nut, causing a rolling friction between the balls and the screw shaft or the nut when the nut moves with respect to the screw shaft, so that the force provided from the ball screw assembly for moving the motor is effective. Thus, after a prolonged contact between the screw shaft and the balls, the contact surface of the screw shaft is easy to collect dust, so that the nut need to install a cleaning structure to carry out the cleaning of the screw shaft.

However, the conventional cleaning structure just has one wiping protrusion arranged in single pitch of the corresponding screw shaft for cleaning the contact surface of the screw shaft. In other words, if the screw shaft is a double-loop structure, the conventional cleaning structure just has two wiping protrusions, and each wiping protrusion is arranged in single pitch of each loop of the corresponding screw shaft for cleaning the contact surface of each loop of the screw shaft.

To achieve the abovementioned improvement, the inventors strive via industrial experience and academic research to present the instant disclosure, which can provide additional improvement as mentioned above.

### SUMMARY OF THE INVENTION

One embodiment of the instant disclosure provides a ball screw assembly and a wiper each capable of improvement of the cleaning effect of the screw shaft.

The ball screw assembly comprises a screw shaft having a spiral rolling groove formed on an outer surface thereof; a nut having a spiral load rolling groove formed on an inner surface thereof, wherein the screw shaft passes through the nut, and the rolling groove aligns the load rolling groove, and the rolling groove and the load rolling groove surroundingly define a raceway; a plurality of balls disposed between the rolling groove of the screw shaft and the load rolling groove of the nut; and two wipers respectively arranged on two opposite sides of the nut and screwing on the rolling groove. Each wiper comprises a ring having a plurality of dust discharge grooves formed on an inner surface thereof, wherein the inner surface of the ring substantially abuts the outer surface of the screw shaft; and a plurality of wiping protrusions extended from the inner surface of the ring and each wiping protrusion arranged between any two adjacent dust discharge grooves, wherein the wiping protrusions are arranged in and compressed by the rolling groove of the screw shaft, and a portion of the rolling groove touched with the wiping protrusions is arranged in a single pitch of the screw shaft.

The wiper for screwing on a rolling groove of a screw shaft comprises a ring having a plurality of dust discharge grooves formed on an inner surface thereof, wherein the inner surface of the ring substantially configured to abut an outer surface of the screw shaft; and a plurality of wiping protrusions extended from the inner surface of the ring and each wiping protrusion arranged between any two adjacent dust discharge grooves, wherein when the wiper screws on the rolling groove of the screw shaft, the wiping protrusions are arranged in and compressed by the rolling groove of the screw shaft, and a portion of the rolling groove touched with the wiping protrusions is arranged in a single pitch of the screw shaft.

Base on the above, the ball screw assembly and the wiper are used for cleaning the rolling groove corresponding to each single pitch of the screw shaft by the wiping protrusions simultaneously, and the ball screw assembly and the wiper are used for discharging the dust via the dust discharge groove.

### BRIEF DESCRIPTION OF THE DRAWINGS

FIG. 1 is a perspective view of a ball screw assembly according to the instant disclosure;

FIG. 2 is an exploded view of FIG. 1;

FIG. 3 is an exploded view showing another angle of FIG. 2;

FIG. 4 is a partial cross-sectional view along the longitudinal direction of the screw shaft of FIG. 1;

FIG. 5 is an exploded view showing a wiper and an end cap according to the instant disclosure;

FIG. 6 is an exploded view another angle of FIG. 5; and

FIG. 7 is a perspective view showing the wiper and the end cap according to the instant disclosure.

### DETAILED DESCRIPTION OF THE PREFERRED EMBODIMENTS

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

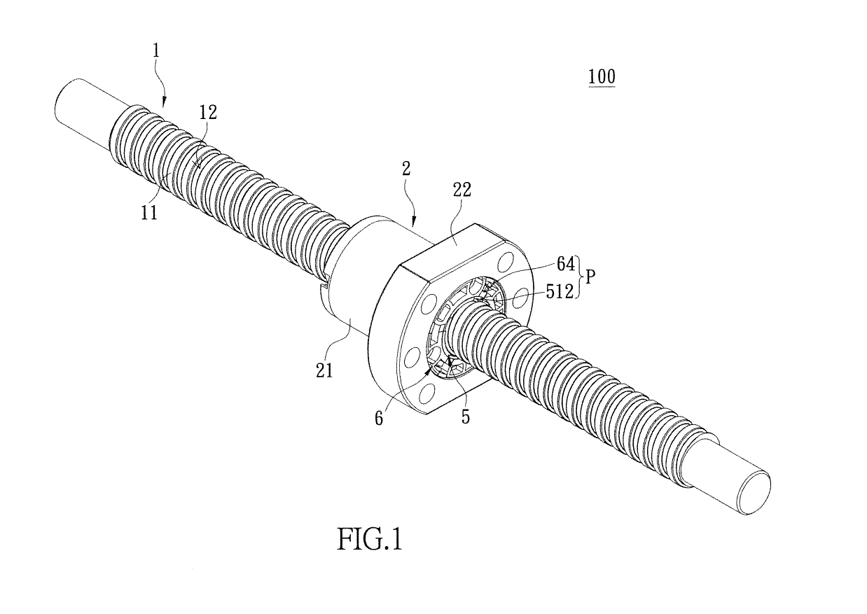

Please refer to FIG. 1, which shows a ball screw assembly 100 of the instant disclosure. The ball screw assembly 100 of this embodiment takes an end cap-type ball screw assembly 100 with a single-loop for example, but the type of the ball screw assembly 100 is not limited to this embodiment.

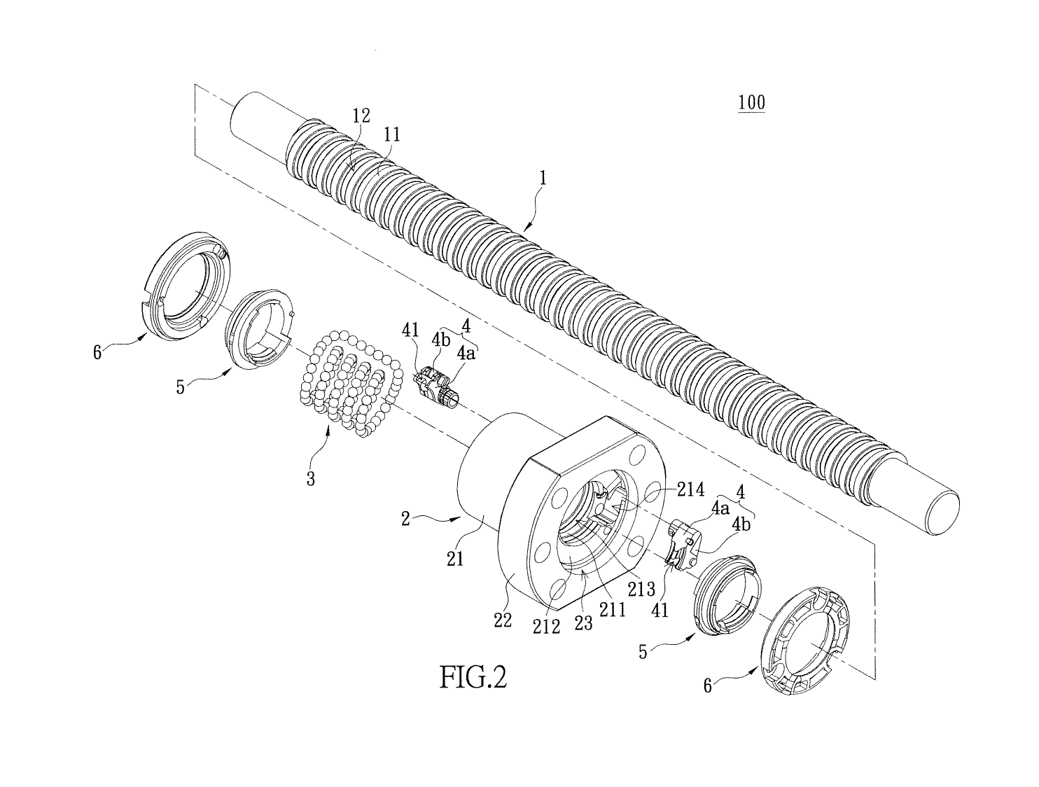

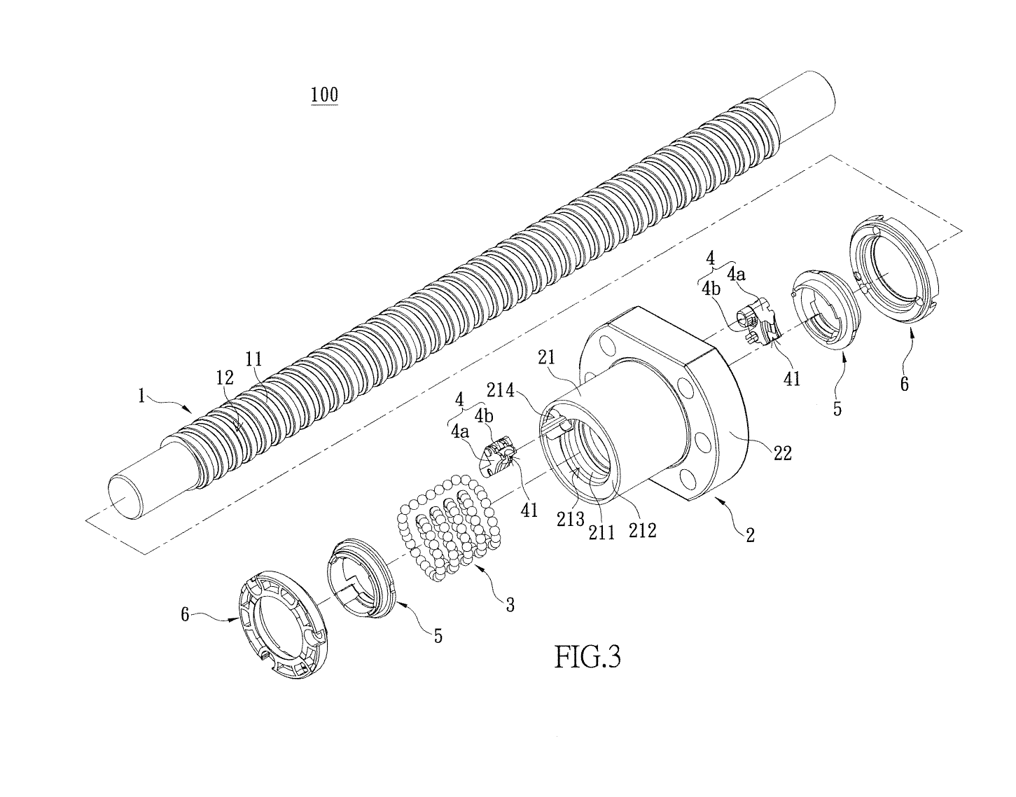

Please refer to FIGS. 2 through 4, the end cap-type ball screw assembly 100 has a screw shaft 1, a nut 2, a plurality of balls 3, two circulators 4, two wipers 5, and two end caps 6. The screw shaft 1 has a substantially cylindrical shape. The screw shaft 1 has a spiral rolling groove 12 formed on an outer surface 11 thereof.

The nut 2 has a tubular main body 21 and an annular shaped receiving body 22 integrally extended from an end of the main body 21. The main body 21 has a spiral load rolling groove 213 formed on an inner surface 211 thereof. The main body 21 has two accommodating slots 214 and a tubular connecting passage 215 in air communication with the accommodating slots 214.

Specifically, the shape of each accommodating slot 214 conforms to the shape of each circulator 4. The accommodating slots 214 are respectively formed on two opposite lateral surfaces 212 of the main body 21. The connecting passage 215 is air communicable with the bottom of one accommodating slot 214 at one end of the connecting passage 215 and to the bottom of another accommodating slot 214 at another end of the connecting passage 215.

The inner diameter of the receiving body 22 is larger than the inner diameter of the inner surface 211 of the main body 21. The inner surface of the receiving body 22 and the corresponding lateral surface 212 of the main body 21 jointly define a receiving slot 23. An oiling hole (not shown) is formed from the outer surface of the receiving body 22 to the load rolling groove 213.

The screw shaft 1 passes through the nut 2, and the connecting passage 215 is substantially parallel to the axial direction of the screw shaft 1. The rolling groove 12 aligns with the load rolling groove 213, and the rolling groove 12 and the load rolling groove 213 jointly define a raceway A. Moreover, some of the balls 3 are sequentially disposed between the rolling groove 12 of the screw shaft 1 and the load rolling groove 213 of the nut 2 such that the balls can roll in the raceway A. The lubricating oil can be injected into the raceway A via the oiling hole to reduce the friction, generated from the balls 3, between the balls 3, the rolling groove 12 and the load rolling groove 213.

The circulators 4 are respectively disposed on the accommodating slots 214 which are arranged on the opposite sides of the nut 2. Each circulator 4 defines an arched circulating passage 41. Two ends of each circulating passage 41 are air communicable with the raceway A and the connecting passage 215, such that the raceway A, the connecting passage 215, and the circulating passages 41 form as a loop. The circulators 4 are arranged with 180 degrees rotation symmetry with respect to a center of the connecting passage 215.

The balls 3 are sequentially recirculated through the raceway A, one of the circulating passages 41, the connecting passage 215, and another circulating passage 41, so that the balls 3 are capable of circulating in the raceway A by the circulating passages 41 and the connecting passage 215.

Specifically, each circulator 4 in this embodiment for example is a non-cutaway structure, which includes a first plastic member 4a and a second plastic member 4b. Each circulator 4 can also be formed integrally, but not limited to this embodiment.

The wipers 5 have identical structures, so that the following description states the detailed features of one wiper 5, and the detailed features about an inner portion of the wiper 5 is stated below.

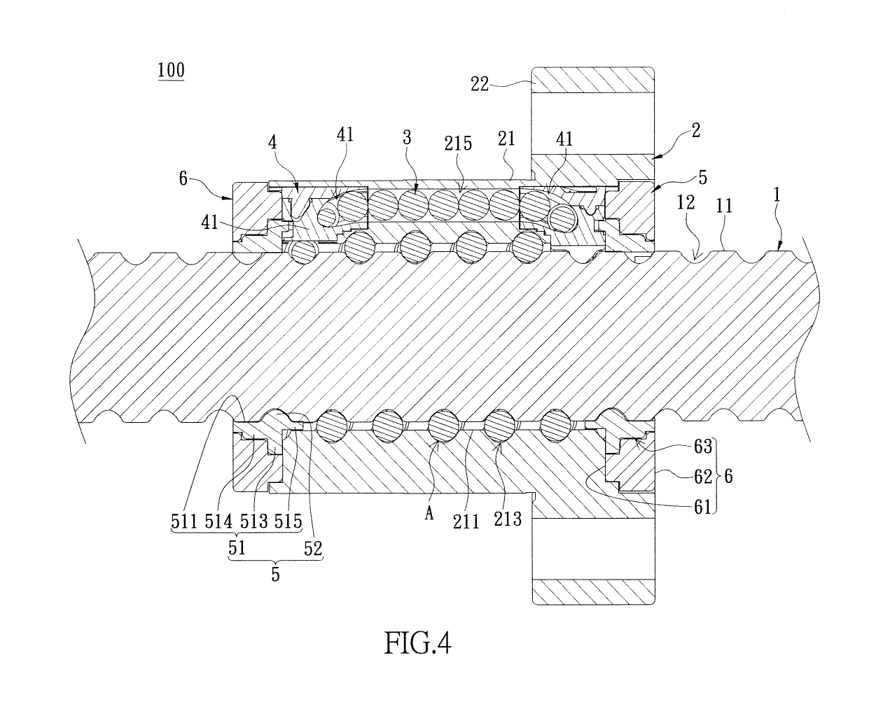

Please refer to FIGS. 4 through 6, each wiper 5 has an annular shape. Each wiper 5 includes a ring 51 and a plurality of wiping protrusions 51 extended from an inner surface 511 of the ring 51. The ring 51 has a plurality of dust discharge grooves 512 formed on the inner surface 511 thereof, that is to say, the distance between the bottom of each dust discharge groove 512 and the center of the ring 51 is larger than the distance between the inner surface 511 of the ring 51 and the center of the ring 51.

Specifically, each wiping protrusion 52 is arranged between any two adjacent dust discharge grooves 512. In this embodiment, the quantity of wiping protrusion 52 of each wiper 5 is three for example, and the quantity of dust discharge groove of each wiper 5 is four for example, but not limited to this embodiment. In more details, each dust discharge grooves 512 is formed between an edge of the inner surface 511 of each ring 51 such that each dust discharge groove 512 is arranged between any two adjacent wiping protrusions 52.

Moreover, each wiping protrusion 52 has an elongated shape, and each wiping protrusion 52 has a plurality of identical cross-sections perpendicular to the longitudinal direction thereof. In this embodiment, each wiping protrusion 52 takes the elongated shape for example, but each wiping protrusion 52 can be designed to the other shape (e.g., spiral shape).

Each ring 51 has a positioning rim 513 having two opposite ends, a main portion 514 extended from one end of the positioning rim 513, and an extending wall 515 extended form another end of the positioning rim 513. Specifically, the outer diameter of positioning rim 513 is larger than the outer diameter of the main portion 514, and the outer diameter of positioning rim 513 is larger than the outer diameter of the extending wall 515. The wiping protrusions 52 and the dust discharge grooves 512 are formed on the inner sides of the positioning rim 513, the main portion 514, and the extending wall 515.

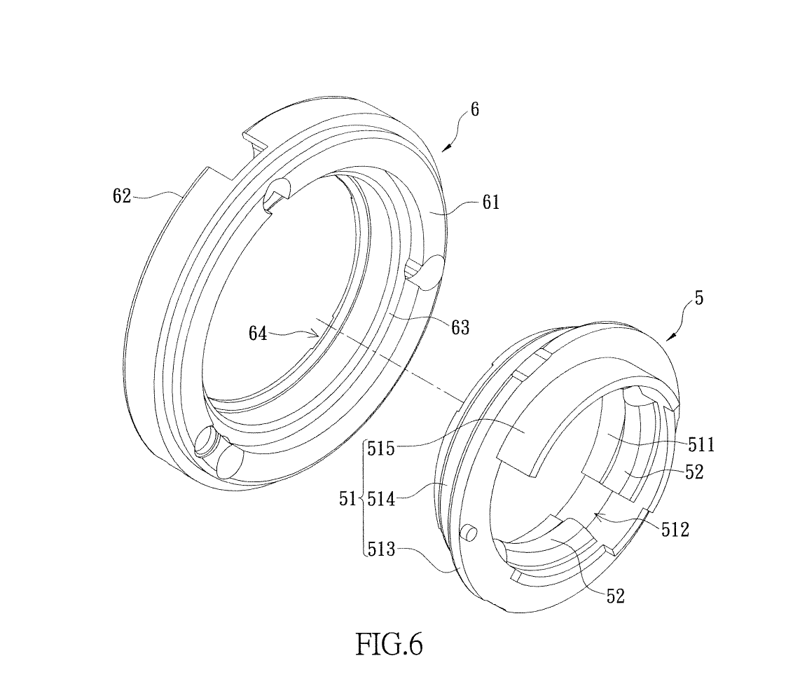

The extending wall 515 has an annular stepped shape. Specifically, the wiping protrusions 52 of each wiper 5 are extended in sequence from the inner surface of the main portion 514 to the inner surface of the extending wall 515 along a spiral direction as shown in FIG. 6, such that the extending wall 515 is formed to provide the spiral arrangement of the wiping protrusions 52. In other words, the wiping protrusions 52 extend away from the main portion 514, and the extending wall 515 correspondingly extends such that the wiping protrusions 52 are arranged on the inner surface thereof. At least one of the dust discharge grooves 512 is extended to the inner side of the extending wall 515, but not penetrating the extending wall 515.

The wipers 5 are configured towards the main body 21 of the nut 2 via the extending wall 515, and respectively screwed on and coupled with the rolling grooves 12, such that the wiping protrusions 52 are configured in and abut the rolling groove 12 of the screw shaft 1. Moreover, the wiping protrusions 52 of the wipers 5 are arranged within a single pitch of the screw shaft 1.

About the ball screw assembly 100, the inner surface 511 of each ring 51 abuts the outer surface 11 of the screw shaft 1, and the dust discharge grooves 512 are oppositely formed on a portion of the inner surfaces 511 of the ring 51 such that each dust discharge groove 512 arranged between any two adjacent wiping protrusions 52.

When using the ball screw assembly 100, the rolling groove 12 corresponding to each single pitch of the screw shaft 1 can be simultaneously cleaned by the wiping protrusions 52 of each wiper 5, so that cleaning of the rolling groove 12 is improved.

The instant embodiment takes the ball screw assembly 100 with single-loop for example, but the ball screw assembly 100 in another embodiment (not shown) can be a ball screw assembly with double-loop or multi-loop. A plurality of the wiping protrusions and the dust discharge grooves are arranged in a single pitch of each loop of the corresponding screw shaft such that the contact surface of each loop of the screw shaft is efficiency cleaned.

Moreover, the skilled person can easily understand the structure of the above ball screw assembly with double-loop or multi-loop according to the above ball screw assembly 100 with single-loop, so that the structure of the above ball screw assembly with double-loop or multi-loop is not stated again.

The end caps 6 are the identical structure, so that the following description states the detailed features of one end cap 6.

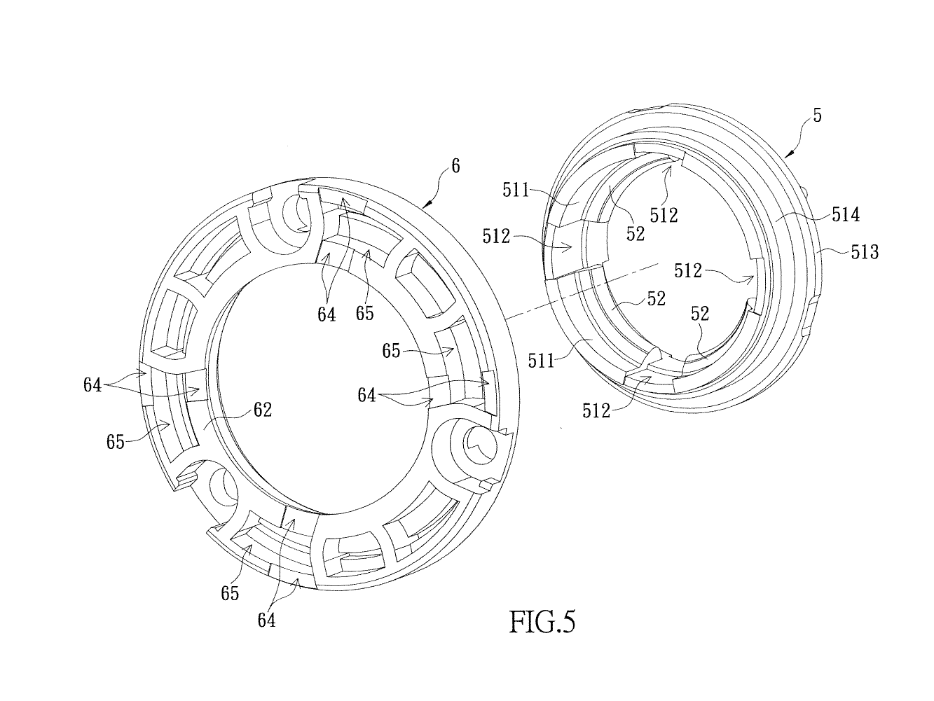

Please refer to FIGS. 5 and 6, each end cap 6 has a first end surface 61 and an oppositely arranged second end surface 62. The inner portion of each end cap 6 is a stepped structure 63. The stepped structure 63 of each end cap 6 conforms in shape to the positioning rim 513 and the main portion 514 of each wiper 5. Moreover, each wiper 5 is received in each end cap 6. The surface of positioning rim 513, which is away from the main portion 514, and the first end surface 61 are in a coplanar arrangement.

Each end cap 6 has an annular shape, and each end cap 6 has a plurality of dust discharge outlets 64 formed on the second end surface 62 along the radial direction of each end cap 6. The number of the dust discharge outlets 64 of each end cap 6 is equal to the number of the dust discharge grooves 512 of each wiper 5, and the width of each dust discharge outlet 64 is smaller than the width of the each dust discharge groove 512.

Please refer to FIGS. 4, 5, and 7, the first end surface 61 of the end caps 6 correspondingly abuts the main body 21 of the nut 2. The stepped structure 63 of each end cap 6 conformingly couples with the main portion 514 and the positioning rim 513 of each wiper 5, so that the end caps 6 are respectively fixed on the nut 2 and the screw shaft 1 can pass through the end caps 6. Specifically, one of the end caps 6 is received in the receiving slot 23, and each wiper 5 is arranged between each end cap 6 and a side of the main body 21 of the nut 2 adjacent to the wiper 5. Moreover, the second end surfaces 62 of the end caps 6 are exposed from the nut 2. Each dust discharge outlet 64 of each end cap 6 respectively aligns with each dust discharge groove 512 of each wiper 5 to define a dust discharge passage P.

Thus, when the wiping protrusions 52 are scraping the rolling groove 12, the dust adhered on the rolling groove 12 is separated from the rolling groove 12 and is discharged via the dust discharge passage P for maintaining the smoothness of the rolling groove 12.

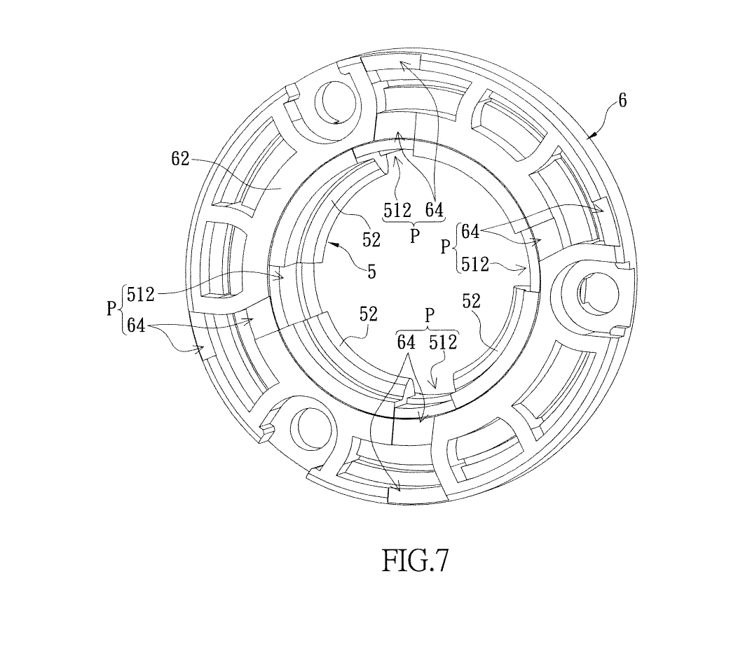

The following description states the preferable type of the dust discharge passage P. An inner side wall of each dust discharge groove 152 aligns with and is arranged coplanar to an inner side wall of each dust discharge outlet 64. Specifically, the dust discharge outlets 64 of each end cap 6 are arranged on two sides of the second end surface 62 of each end cap 6 (For example: the two dust discharge outlets 64 at the lower left corner of FIG. 7 and the other two dust discharge outlets 64 at the upper right corner of FIG. 7). The smallest arc length between the two adjacent dust discharge outlets 64 is substantially identical to the largest arc length between the two adjacent dust discharge grooves 512 of each wiper 5 corresponding to the two dust discharge outlets 64.

Additionally, each end cap 6 has a plurality of openings 65 formed on the second end surface 62 thereof, and the opening 65 of each end cap 6 are arranged in a circular configuration. Each opening 65 is air communicable with each dust discharge outlet 64, and the depth of each dust discharge outlet 64 is smaller than the depth of each opening 65.

Base on the above, when the ball screw assembly provided by this embodiment is used, the rolling groove corresponding to each single pitch of the screw shaft is simultaneously cleaned by the wiping protrusions of each wiper, so that the rolling groove is relatively cleaner.

Moreover, when the wiping protrusions are scraping the rolling groove, the dust adhered on the rolling groove is separated from the rolling groove and is discharged via the dust discharge passage for maintaining the smooth of the rolling groove.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A ball screw assembly, comprising:
a screw shaft having a spiral rolling groove formed on an outer surface thereof;
a nut having a spiral load rolling groove formed on an inner surface thereof, the screw shaft coupled through the nut, the rolling groove aligning with the load rolling groove, and the rolling groove and the load rolling groove jointly defining a raceway;
a plurality of balls disposed between the rolling groove of the screw shaft and the load rolling groove of the nut; and
two wipers respectively configured on two opposite sides of the nut and coupled with the rolling groove, wherein each wiper comprises:
a ring having a plurality of dust discharge grooves formed on an inner surface thereof and the inner surface of the ring substantially abuts the outer surface of the screw shaft; and
a plurality of wiping protrusions extended from the inner surface of the ring and each wiping protrusion arranged between any two adjacent dust discharge grooves;
wherein the wiping protrusions abut and are arranged in the rolling groove of the screw shaft, and the wiping protrusions of the wipers are arranged within a single pitch of the screw shaft.

2. The ball screw assembly as claimed in claim 1, wherein at least one of the plurality of dust discharge grooves is formed on the inner surface of the ring from a distal end of the ring to a portion between two adjacent wiping protrusions.

3. The ball screw assembly as claimed in claim 1, wherein each wiping protrusion has an elongated shape, and each cross-sectional area of the wiping protrusion along the longitudinal direction is identical.

4. The ball screw assembly as claimed in claim 1, wherein each ring has a positioning rim having two opposite ends, a main portion extended from one end of the positioning rim, and an extending wall extended form another end of the positioning rim, the wiping protrusions of each wiper extend from the inner side of the main portion to the inner side of the extending wall, and the extending wall of each wiper correspondingly extends from the wiping protrusions.

5. The ball screw assembly as claimed in claim 1, further comprising two end caps coupled to the screw shaft, the end caps are respectively configured on the two opposite sides of the nut, the end caps are respectively assembled with the wipers, and each end surface of the end cap exposed from the nut is formed with a plurality of concaved dust discharge outlets.

6. The ball screw assembly as claimed in claim 5, wherein the dust discharge outlets of each end cap respectively align with the dust discharge grooves of each wiper, and each dust discharge outlet and the corresponding dust discharge groove defined a dust discharge passage.

7. A wiper coupled to a rolling groove of a screw shaft, comprising:
a ring having a plurality of dust discharge grooves formed on an inner surface thereof, and the inner surface of the ring substantially configured to abut an outer surface of the screw shaft; and
a plurality of wiping protrusions extended from the inner surface of the ring and each wiping protrusion arranged between any two adjacent dust discharge grooves,
wherein when the wiper is coupled to the rolling groove of the screw shaft, the wiping protrusions abut and are arranged in the rolling groove of the screw shaft, and the wiping protrusions of the wipers are arranged within a single pitch of the screw shaft.

8. The ball screw assembly as claimed in claim 7, wherein at least one of the plurality of dust discharge grooves is formed on the inner surface of the ring from a distal end of the ring to a portion between two adjacent wiping protrusions.

9. The ball screw assembly as claimed in claim 7, wherein each wiping protrusion has an elongated shape, and each cross-sectional area of the wiping protrusion along the longitudinal direction is identical.

10. The ball screw assembly as claimed in claim 7, wherein each ring has a positioning rim, a main portion extended from one end of the positioning rim, and an extending wall extended form another end of the positioning rim, the wiping protrusions of each wiper extend from the inner side of the main portion to the inner side of the extending wall, and the extending wall of each wiper correspondingly extends from the wiping protrusions.
